(19) United States
(12) Patent Application Publication
(10) Pub. No.: US 2011/0247975 A1
(43) Pub. Date: Oct. 13, 2011

(54) Filtering permeable thermoformed container for beverage-making products with a reinforcement ring

(76) Inventor: Gino Rapparini, Bologna (IT)

(21) Appl. No.: 13/066,133

(22) Filed: Apr. 7, 2011

(30) Foreign Application Priority Data
Apr. 9, 2010 (IT) BO 2010 A 000219

(51) Int. Cl. B01D 63/00

(52) U.S. Cl. 210/321.6

(57) ABSTRACT

An improved filtering permeable thermoformed container is provided which can be formed from a flat film into a shape of a cup for containing water-soluble or brewing products for making beverages wherein an advantageously shaped reinforcement ring supports the film body and a membrane lid in a rigid manner to facilitate the lid being pierced.

### FIELD OF THE INVENTION

The present invention relates to the packaging field and in particular to a filtering permeable thermoformed container for beverage-making products which can be used for single serve brewing machines.

### RELATED APPLICATIONS

This application is related to Italian application BO 2009 A 679 filed by applicant on Oct. 21, 2009, and Italian application BO 2010 A 000219 filed by applicant on Apr. 9, 2010.

### BACKGROUND OF THE INVENTION

There are known filtering permeable containers for making beverages for single serve brewing machines, obtained by thermoforming from a flat film and closed with a filter paper membrane. These containers may have an impermeable cup made of stiff plastic which contains a cup-shaped filter inside. The filter may be made of paper or polymer material and generally has a flat bottom wall spaced from the flat bottom portion of the cup so as to provide an area for receiving a brewed beverage. The plastic cup has a cover which may be pierced by a tube to inject heated liquid into the filter. When the liquid permeates through the filter wall, the beverage is collected in the bottom of the cup and an outlet probe is used to pierce the bottom of the cup to extract the beverage.

Typical of the prior art container which the present invention is designed to improve on, is disclosed in U.S. Patent Application Publication No. 2005/0051478 to Karanikos and Rossi. FIG. 1 from the Karanikos Patent Application Publication illustrates this type of cup, and is represented within at FIG. 15.

Italian patent application BO 2009 A 679 filed by applicant on Oct. 21, 2009 relates to the manufacture of containers for beverage-making products. Existing filters are not sufficiently rigid to be used directly as containers in the known dispensing machines and are therefore pre-packed inside a stiff plastic container and closed with barrier-film membranes or inserted inside a reusable plastic molded adaptor, usually supplied with known dispensing machines.

In addition, many existing containers utilize excessive material by using inner and outer cups for the necessary functions to be performed by the container, and accordingly fail to meet ecological standards for biodegradability. For example, as described above, many containers utilize a stiff plastic outer cup which requires piercing of the bottom of the cup to permit fluid to be released from the cup.

Furthermore, use of biodegradable and/or compostable materials such as PLA, Mater Bi or blends of these and other resins, entail specific challenges for the production and design of a container. For example, use of biodegradable and/or compostable material can impose design challenges which, without the benefit of the present invention, and can result in the use of excessive and expensive material.

### OBJECTS OF THE INVENTION

It is therefore one objective of the present invention to provide a container that would solve the problems and improve containers currently used in the industry, such as those that are discussed above.

An object of this invention is to provide an improved container over the existing art for use with existing machines that is stiff enough to support the piercing of the injecting needle and the pressure of the sealing gasket to be used with known common domestic dispensing machines and in the more sophisticated professional ones, without using complicated adaptors.

It is also an object of the invention to provide a container which can be used in existing brewing machines and machines while requiring only a single needle or other device for piercing a portion of the top of the container, which needles can inject hot water into the container for brewing. The brewed beverage may then pass through the filter and funnel into drinking receptacles without the need for a second (2nd) needle to puncture the bottom of an outer container.

It is also an object of the invention to provide a container which can be used in existing brewing machines having a sealing gasket or other device to avoid the escape of hot water injected into the container by a needle or other device through an aperture in the container which may be created by a needle.

It is a further object of the invention to provide a container having a top lid surface with sufficient tension to permit piercing of the top lid surface by a needle of a brewing machine used for injecting hot water into the container.

It is a further object of the invention to provide a container having a stiff and flat membrane which can be readily penetrated by a needle in existing brewing machines where the container has a top lid surface with sufficient tension to permit a mating gasket surface of a brewing machine to securely grip and support the top lid surface of the container and prevent the escape of hot water injected into the container by a needle or other device through an aperture in the container created by the needle.

It is further object of the invention to provide a container which does not utilize a hard outer cup surrounding the filter of the container which imposes additional requirements for the disposal of used containers and to utilize ecological materials and to avoid use of excess material to perform the functions of the container.

It is also an object of the invention to provide a container capable of being fabricated from biodegradable materials, and to meet biodegradability and/or compostability standards for a single server beverage container.

It is a further object of the invention to provide a container which does not utilize material forming a hard outer cup surrounding the filter of the container and which requires piercing of the bottom portion of a hard outer cup to permit the release of brewed product and which permits the release of brewed product from the container through the container filter so the brewed product can flow downward by gravity to exit a brewing machine and be readily available to a user.

It is an object of the invention to provide a container having a reinforcement ring and supported rim which avoids the use of complicated adaptors or the introduction of expensive and non-ecological rigid plastic containers.

It is a further object of the invention to provide a container which can be readily removed from a brewing machine after use.

It is a further object of the invention to provide a container which facilitates correct positioning of container in a single serve brewing machine.

It is an object of the invention to provide a container which can utilize non-aluminum based materials for a top membrane and has a container body with pleated portions, whereby the container body can be stiffened to be substantially self-supporting with an improved aesthetic appearance for the container body.

It is a further object of the invention to provide a container having a rim which provides improved handling compared to conventional filter paper coffee pods, and facilitates placement of the container in a single serve brewing machine before the brewing process, and facilitates safe removal of the container after the brewing process when the container may still be hot and wet.

These and other objectives and advantages of the present invention will become evident from the description and drawings that follows.

### SUMMARY OF THE INVENTION

A filtering container is provided for water soluble beverage making products. The container has a water permeable container body thermoformed from a flat film providing container space to receive a water soluble brewing product. In one embodiment, the container body includes a flat rim extending around the opening of the container. A reinforcement ring with a horizontal portion mates with and supports the flat rim of the container body with a substantially flat top surface which forms a complementary ring. The flat rim of the container body can be connected to membrane that closes the opening of the container and with the reinforcement ring, maintains the membrane in a substantially stiff manner. The reinforcement ring has a vertical wall portion connected to the container body for providing additional rigidity to support the membrane in a taut manner.

The reinforcement ring includes a horizontal portion and a vertical portion, either of both of which can be connected to and support the container body to provide a container space which can receive a product such as ground coffee. In one embodiment, the horizontal portion of the reinforcement ring has a substantially flat top surface which forms a ring, which is connected to the membrane and maintains the position and shape of the membrane.

In addition or in the alternative, where the reinforcement ring further comprises a vertical wall portion, the vertical wall portion can intersect the horizontal portion of the flat rim at greater than a right angle, such that the vertical wall portion has a conical shape and leans in an inward direction towards a center axis of the reinforcement ring.

In various embodiments of a filtering container according to the invention, the container body, the reinforcement ring and membrane can be fabricated using biodegradable material.

In another embodiment, the container body includes a flat top rim which is disposed between the top horizontal portion of a reinforcement ring and a bottom surface of the membrane. In addition, the reinforcement ring can be heat sealed and integral to the flat rim. In addition or in the alternative, the top wall portion of the container body can be connected to a vertical wall portion of the reinforcement ring. The top wall portion can be heat sealed to the vertical wall portion of the reinforcement ring.

In an alternative embodiment, the membrane is connected to the top surface of the reinforcement ring and the container body is connected to a bottom surface of the ring.

In a further embodiment, the vertical wall portion has a cylindrical shape, and the membrane is connected to the top surface of the reinforcement ring, and the container body is connected to an outer surface of the vertical wall portion of the reinforcement ring.

It is also possible to provide a container according to the invention having a membrane that is folded around an outer edge of the reinforcement ring and is connected to a bottom surface of the ring. For example, in another embodiment, the horizontal portion of the reinforcement ring has a bottom surface that is connected to the container body.

In a further conceived variation of a container according to the invention, the container body includes pleated portions whereby the container body is stiffened so as to be substantially self-supporting. A container body can also include a sleeve which provides a lesser permeable portion of the container body. In addition, the container body can include a spreader disc at a bottom center area of the container body. The spreader disc can cooperate with the container body to provide a lesser permeable portion of the container body. The spreader disc can be provided on an outside surface of the container body and be removable by a user. In addition, the spreader disc can include an aperture disposed at a center area of the disc.

In a further embodiment a filtering container is provided having a container body and a membrane. In such an embodiment, the membrane is folded around an outer edge of a rim, or horizontal portion of the container body and is connected to the lower surface of a rim, thereby maintaining the membrane in a substantially stiff manner. In addition, a resin can also be provided in an overlapping portion of the membrane and rim, and in which overlapping area the resin, membrane and rim are heat-sealed thereby improving the stiffness of the membrane.

In another embodiment, the container body includes pleated portions. The pleated portions can be partially flattened and overlap one near the vertical wall portion of the reinforcement ring. In addition, or in the alternative, the container body can include that have an expanded state and a collapsed storage state. In the collapsed storage state, the pleated portions can be partially flattened and overlap one another to reduce bulk of the container such as during storage or shipping, and which can revert to an expanded state, such as when in use.

### BRIEF DESCRIPTION OF THE DRAWINGS

Preferred embodiments of the inventive devices are illustrated in the drawings and are described below, though not necessarily to scale. The invention is explained in detail, referring to the figures of the drawings, enclosed as non-limiting examples.

FIG. 1 illustrates a perspective view of an embodiment of a container body for a container according to the invention.

FIG. 2 illustrates a side cross-section perspective view of an embodiment of a container body with a reinforcement ring for a container according to the invention.

FIG. 3 illustrates a side cross-sectional view of an embodiment of a container with a closing membrane lid according to the invention and filled with a brewing material.

FIG. 4 illustrates a perspective view of an embodiment of a container with closing membrane according to the invention.

FIG. 5 illustrates a perspective view of an embodiment of a container according to the invention, such as shown in FIG. 3.

FIG. 6 illustrates a side cross-sectional view of an embodiment of a container according to the invention, such as shown in FIG. 3, with portions of machine components for a brewing machine for which the container is adapted for use with a needle poised to pierce the top membrane cover.

FIG. 7 illustrates a side cross-sectional view of an embodiment of a container according to the invention, such as shown in FIG. 3, with portions of machine components for a brewing machine for which the container is adapted for use wherein the needle has pierced the membrane.

FIG. 8 illustrates a vertical cross section view of a portion of a brewing machine and an embodiment of a container according to the invention.

FIG. 9 illustrates a side cross-sectional view of another embodiment of a container according to the invention, and containing a brewing material.

FIG. 10 illustrates a perspective view of a container body for an embodiment of a container according to the invention.

FIG. 11 illustrates a cross sectional side view of an embodiment of a container according to the invention.

FIG. 12 illustrates a perspective view of an embodiment of a container according to the invention.

FIG. 13 illustrates a side cross-sectional view of an embodiment of a container according to the invention with portions of machine components for a brewing machine for which the container is adapted for use.

FIGS. 14a and 14b illustrate an alternative embodiment of a container body according to the invention, with FIG. 14a showing a bottom cross-section view of a lower portion of the container body, and FIG. 14b showing a cross-section view of the upper portion of the container body.

FIG. 15 illustrates a prior art solution.

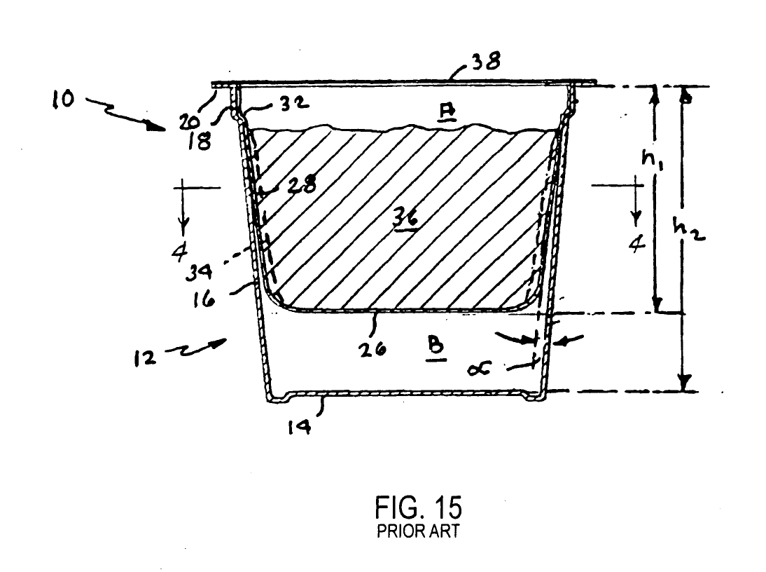

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

A detailed description of a filtering permeable container which can be used with a single server brewing machine is provided below. In addition, several specific embodiments are provided as examples of the devices which one of ordinary skill in the art may apply these teachings to address specific problems and to illustrate the benefits and improvements of the system over known solutions.

Italian applications BO 2009 A 679, BO 2010 A 000219, and PCT application PCT/EP2010/006389, of which applicant is an inventor, are relevant to the present invention.

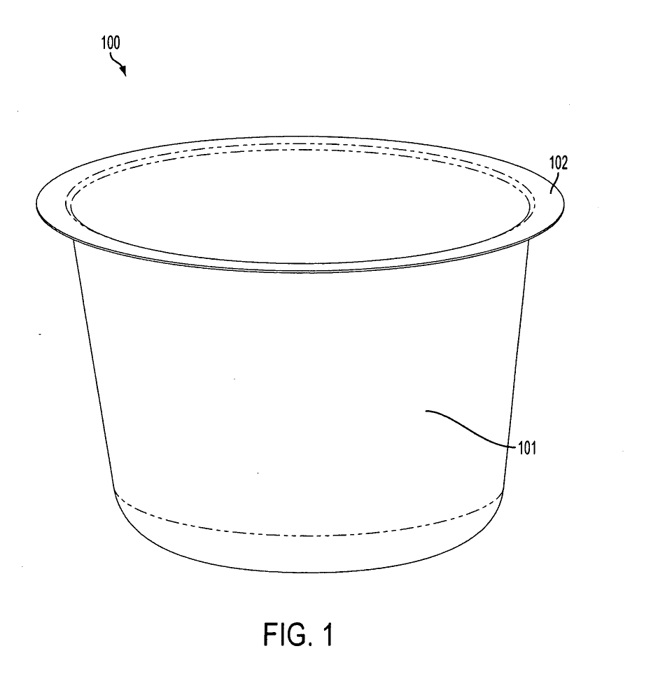

FIG. 1 illustrates an embodiment of a container 100 according to the invention. The container 100 includes a container body 101 made of a thermoformed filtering permeable material. An embodiment of the container body includes a flat top rim 102. Through the top opening of the container body 101, a brewing product can be deposited into the interior space of the container 100.

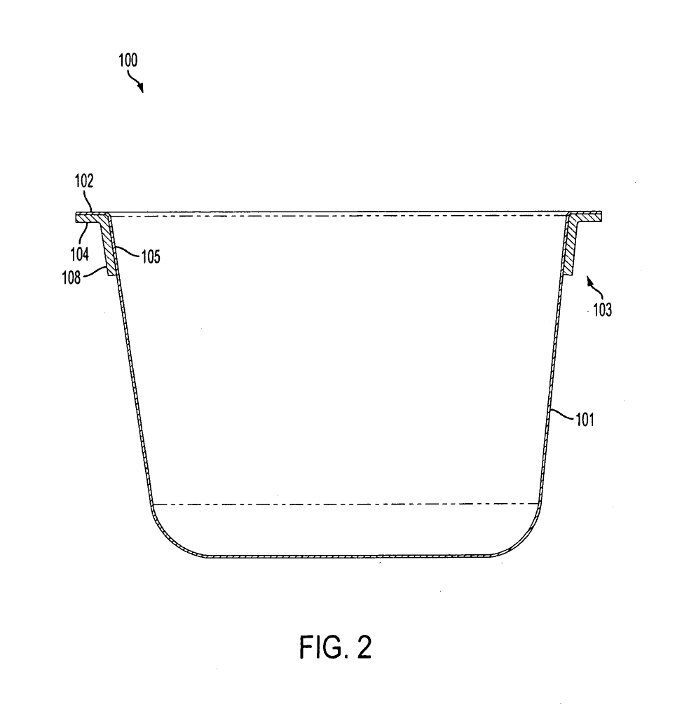

As illustrated in FIG. 2, an embodiment of the container body 101 is provided with a reinforcement ring 103 which has a flat top portion 104 and skirt shaped cylinder wall portion 108 which extends partially down the outside surface of the container body 101. The flat top portion 104 supports the top rim 102 of the container body. The wall portion 108 can support the top wall portion 105 of the container body.

The reinforcement ring 103 may be formed as one piece with an angled cross section with the horizontal flat top portion 104 with a substantially flat top surface in the same plane as the top opening of the container body 101, such as in a horizontal plane. The cylinder wall portion 108 is shaped like a skirt which can extend vertically downward from the flat top portion 104. The flat top portion 104 can form a complementary ring and cooperates with the vertical cylinder wall portion 108 to provide a rigid frame. The shape of an upside down L-shaped reinforcement ring with the top portion 104 and cylinder portion 108 provides the stiffness to reinforcement ring 103 in three dimensions, as well as torsional forces along a top plane as well as axial planes.

In one embodiment, the flat top horizontal portion of reinforcement ring 104 is formed to connect with the cylindrically shaped portion 108 of reinforcement ring 103 to form a right angle. Preferably, the flat top horizontal portion of reinforcement ring 104 can connect the cylindrically shaped portion 108 of reinforcement ring 103 at greater than a right angle, whereby a visual extension of the reinforcement ring 103 can form the shape of a cone for even greater stability. For example, the interior side of the cylindrically shaped portion 108, the exterior side or both can form an angle of approximately 7 degrees with an inner axis. Thus the advantageous shape of reinforcement ring 103 provides the ring with greater structural stiffness, and improves the performance of the ring to resist deforming forces. Furthermore, by providing an exterior side of the skirt portion 108 tapered towards the inner axis at its distal end facilitates placement of the container by a user and can improve the seal when the container 100 is placed in a brewing machine.

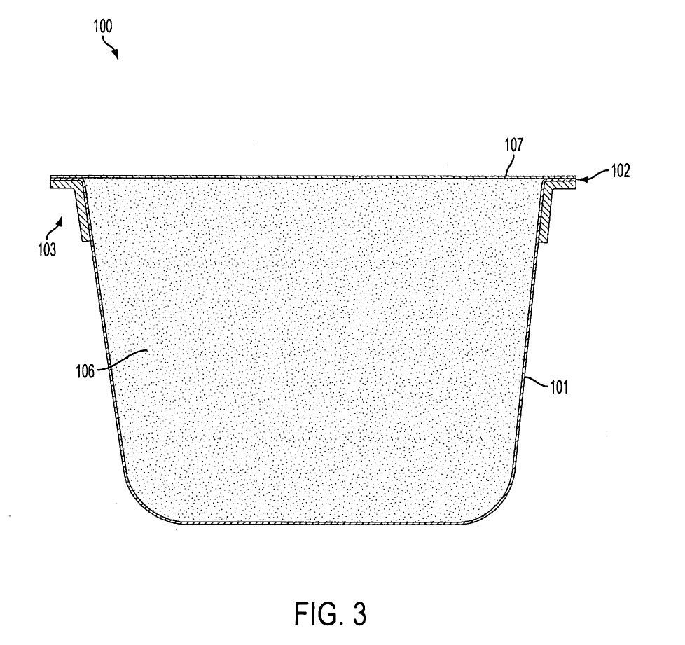

As illustrated in FIG. 3, the ring 103 also provides a stiff frame for supporting the container body 101 to receive a closing membrane 107. The ring 103 is connected to an outer edge of the container body 101 to support the container body 101 and which can provide a circular shaped top opening for the container body 101 to support the closing membrane 107 in a taut manner. An embodiment of the container 100 has the ring 103 connected to the container body at an interior side of the ring 103.

In one such embodiment of a container adapted for use with a single server brewing machine, the inner side of the vertical wall of the cylindrically shaped portion 108 of the reinforcement ring 103 can also help drive downwards the hot water through the brewing material, and prevent the water from prematurely exiting through the container body before contacting the brewing material in the container.

In addition, by providing the ring 103 with a flat top portion 104 connected to a skirt shaped cylindrical wall portion 108, the ring 103 of a container 100 is provided with improved structural stability with a minimum of material which also provides additional benefits such as providing the closing membrane 107 with improved stiffness. Accordingly, the advantageous shape of the ring 103 provides the additional functions and other benefits to the container as well, such as improving the performance of the container to cooperate with a brewing machine by improving a seal that is formed by providing improved support for the container 100 within the machine, and for facilitating the flow of fluid through the brewing material before exiting through the container body 101, among other things.

The ring 103 can be provided in an approximate shape of a circular ring to suit machines for which the container 100 is adapted for use. It can be appreciated that the ring 103 and the rim of the body 102 can be formed into other non-circular shapes, such as matching ovals, rectangles or squares. Preferably, the ring 103 can be formed to include a vertical portion having an approximate shape of a cylinder to make efficient use of materials while providing for the structural support of the container body 101 and other functions of the ring 103. In one embodiment of a container 100, the top wall portion of the container body 105 can be heat sealed, or partially heat sealed, to the same vertical wall portion of the reinforcement ring 103 during fabrication, such as during the thermoforming operation of the container body 101, thereby improving the performance of the container 100.

The ring 103 can be made of oil based plastics or of biodegradable/compostable materials, such as PLA, Mater Bi or blends of biomaterials. The material of the ring 103 is preferably chosen to provide enough rigidity for the design of the rim so that a stiff outer shell cup, such as provided in contemporary designs, is no longer necessary. The ring's flat horizontal ring portion 104 can facilitate the placement of the container in position in a brewing machine, and facilitate removal of the container after use, which might still be hot and wet. The ring's flat top-horizontal portion 104 also supports and can be sealed to the top rim 102 and the barrier film membrane 107 to the top rim 102 to provide a cover for the container 100. The ring 103 can also be fabricated and shaped to assure a correct positioning of the container in a brewing machine.

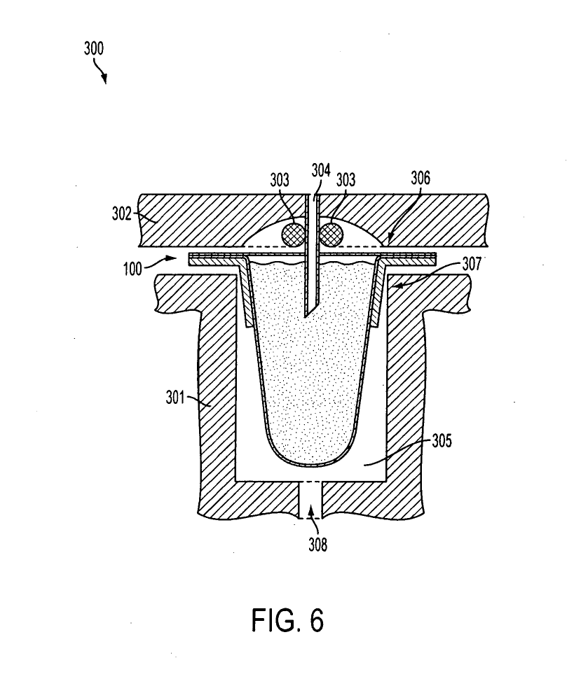

FIG. 3 illustrates an embodiment of a container 100 including the container body 101 with a flat rim 102 and a barrier-film membrane 107. The barrier film membrane 107 provides a top cover to the container 100 and completes the closure of the container 100 after product has been added to the interior space as illustrated in FIG. 6. The barrier film membrane 107 can also provide a surface through which a needle or other device can pierce the membrane 107 to add fluid to the interior space of the container 100. FIG. 6a illustrates the needle 304 after it has pierced the membrane 107. The flat top rim portion 102 of the container body 101 can be connected to the membrane 107 by heat sealing, wherein the material of the rim 102 and membrane 107 can partially meld. The top of the reinforcement ring 104 is heat sealed to the rim 102. For example, the membrane 107 and container body 101 can be formed of materials which include a crossed-fiber mesh. Thus, the membrane 107 and rim 102 of the container body 101 can be caused to meld or melt during fabrication, such as by heat-sealing, to form a strong connection. It can be appreciated that other methods of connecting parts of the container can include ultrasonic, hot melt and RF welding.

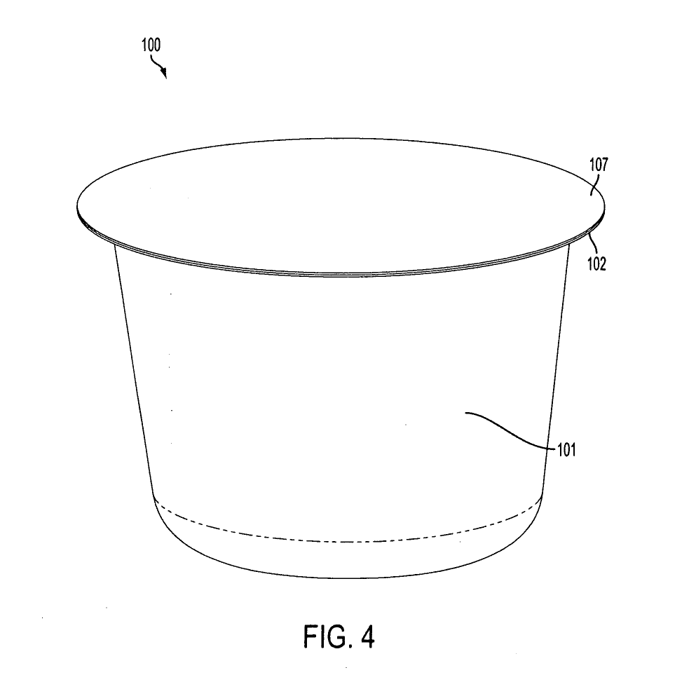

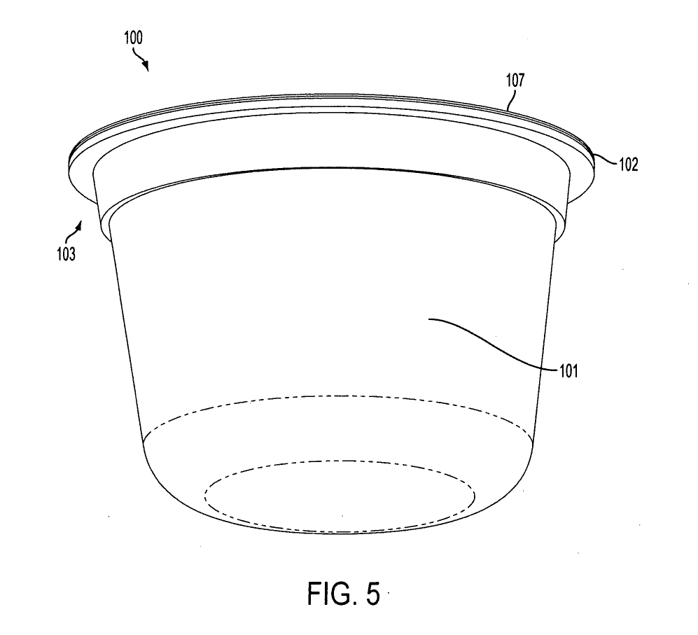

FIGS. 4 and 5 illustrate the container of FIG. 3 in top and bottom perspective.

During fabrication of an embodiment of a container according to the invention, the reinforcement ring 103 can be heat-sealed to a flat filterable, thermoformable material which is to form the container body at a flat top horizontal portion of the reinforcement ring 104. Thereafter the container body can be thermoformed to provide the desired shape and a space within the container to receive a product. Thereafter, the product can be inserted into the container. After this, the container space can be closed by heat sealing a membrane to the top of the flat portion of the container body which has been itself heat sealed to the top of the horizontal portion of the reinforcement ring.

The membrane 107 can be fabricated from a variety of laminates, bioresins or other biomaterials, thus contributing in making the container biodegradable and/or compostable, and compliant with standards such as ASTM6400. Preferably, the membrane 107 is fabricated from material such that once connected to the container 100 during fabrication, the membrane 107 is rigid and is substantially impermeable to liquids. The benefits of providing a substantially stiff membrane 107 with a ring 103 of improved stiffness includes improved perforation by a needle of a brewing machine.

FIG. 3 illustrates a container body 101 that is preferably made of permeable film to permit fluid to pass through the container. For example, the container body 101 can be formed of a filterable membrane which can be thermoformed into the approximate shape of a cup or pail, thereby forming an outer wall and an interior space for receipt of a product. In one embodiment, the container body 101 is formed from a flat film made of permeable, filterable material which is thermoformed into the desired shape.

In addition, the container body 101 can be formed of a single material provided the material can both provide support to contain the product for storage in the interior space and can be permeable to fluid when the container is applied for its intended use in a single serve brewing machine. Filtering, permeable, thermoformable material appropriate for an embodiment of a container body include Smash™, supplied by Asahi Kasei Fibers Corporation, JAPAN. The material for the container body 101 preferably provides excellent filtering features for the containers intended use while allowing for an optimal extraction of the product, such as ground coffee, tea, cocoa, or milk powder. In addition, the choice of material preferably provides excellent thermoforming features, allowing the material to be formed into a deep container for the dry medium, important for an optimal extraction and infusion. Furthermore, it can be appreciated that the choice of material depends on its intended use and the thickness of the material chosen for such use. For example, the thickness of the material offers different degrees of permeability, allowing variation in the time the dry medium will be in contact with hot water in a brewing machine, before the extraction process has been completed, and thus materials of different thicknesses can be chosen depending on the type of material to be used with the container.

The material of the container body can be chosen to very light and thin and the amount used to form the body chosen so that its percentage within the overall package is less so as to meet the biodegradability and/or compostability requirements of a single serve brewing container, such as according to ASTM6400.

FIG. 6 shows a container according to the invention adapted for use with a machine type 300, such as a coffee maker or other single serve brewing machine. The container 100 includes a container body 101, a ring 103, and a barrier-film membrane 107, as described above for FIG. 3 and adapted for use with the machine 300. The machine 300 includes a container receiving portion 301 for receiving the container 100 and a reservoir 305 for receiving fluid that has passed through the container 100. The container receiving portion 301 can include an exit aperture 308 for providing an outlet for the fluid and/or gas pressure. The container receiving portion 301 has a locking portion 307 which provides a support surface which cooperates with the ring 103 of a container 100. Accordingly, an embodiment of a lid 302 according to the device is preferably adapted to provide a snug fit with the supporting portion 307 of the machine. For example, the-ring 103 provides structural support for the container 100 when placed in the machine, and provides a seal by cooperating with the container receiving portion 301 and a lid 302 of the machine 300. The machine has a needle 304 or other means for delivering fluid into the container 100 such as a tube or conduit. The needle 304 is typically part of the lid 302 and can cooperate with the closing of the lid 302 upon the container to pierce the membrane 107 and cooperate with the ring 103 and container receiving portion 301 to form a seal enclosing the container 100.

When closed, the needle punctures the membrane 107 while the gasket 303 forms a seal against the membrane 107 of the container 100. When closed, the needle 304 can introduce pressurized fluid, such as water, into the container 100, thereby mixing with the brewing product, such as coffee grounds, in the container 100. Upon mixing of the fluid into the container, the fluid absorbs some of the brewing product and exits the container through the permeable portions of the container body 101, whereafter the fluid can be stored in the reservoir 305 and/or exit through the exit aperture 308.

In view of the above application of a container according to the invention shown in FIG. 3, for example, it can be appreciated that the ring 103 can be provided in a shape and dimension adapted to be received by a machine for which the container 100 is intended to be used. The flat horizontal portion of the reinforcement ring 104 can be provided to form part of the seal with the brewing machine, such as by enclosing the container and applying pressure to the flat horizontal portion of the reinforcement ring 104.

FIG. 3 illustrates an embodiment of a container body 101 made of filtering permeable thermoformable material that includes a flat top rim 102 that can be at least partially cone-shaped, and/or provided with a rounded bottom portion, or a bottom portion that is rounded at a bottom edge radius. Providing at least a partially cone-shape to the ring 103 can provide greater structural stability to the ring 103 and facilitate manufacture and introduction of the container 100 into a machine type 300. The flat top horizontal portion of reinforcement ring 104 can be connected to the flat ring rim 102 and the membrane 107 to which it can be solidly joined by application of pressure and heat, among other things. The vertical portion of the reinforcement ring 108 can be connected to an upper wall portion 105 of the container body 101 in varying conical shapes, thereby increasing the stiffness of the container body 101. In addition, the rim 102 of the container body 101 can overlap the top of flat horizontal portion of reinforcement ring 104 and provide for greater adhesion of the container body 101 to the ring 103, and to provide greater adhesion of the barrier film-closing membrane 107 to the rest of the container 100. Accordingly, preferably, the flat horizontal portion of the reinforcement ring 103 and the wall portion 105, the rim of the container 102 and the outer edge of the barrier-film membrane 107 are integrally joined, such as by heat sealing, to provide improved rigidity of the flat surface of the membrane 107 at the top of the container 100.

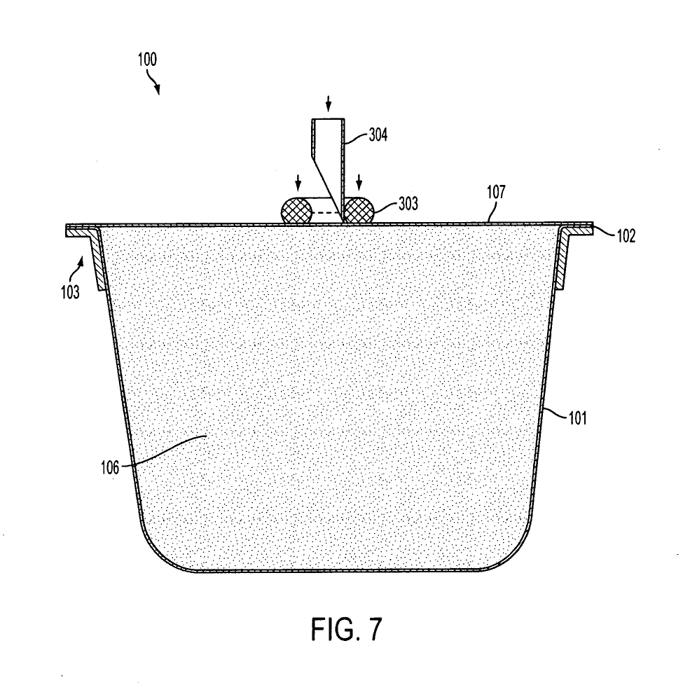

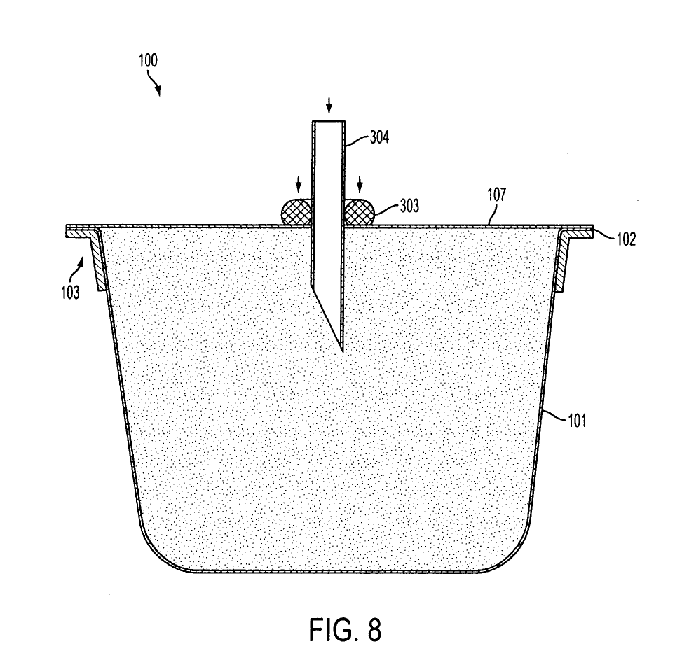

FIGS. 7 and 8 show an embodiment of a container 100 according to the invention adapted for use with a machine type 300, such as a coffee maker or other brewing machine. A container 100 according to the invention can provide improved performance when the gasket 303 and the needle 304 are pressed against the barrier-film closing membrane 107, as shown in FIG. 7. The membrane 107 is stiffened by the integral union of the membrane 107 to the rim of the container 102 and to the reinforcement ring 103, as the needle 304 is pressed against the membrane 107 to pierce the membrane 107 which can maintain an improved seal with the needle 304 and the gasket 303. Arrows are shown in the figure to indicate the direction of force applied by the sealing of the gasket 303 and the piercing of the needle 304. Accordingly, a container 100 according to the invention provides a stiffened membrane 107 which can be perforated by a needle, such as shown in FIG. 8, without requiring bulky outer cups or pails.

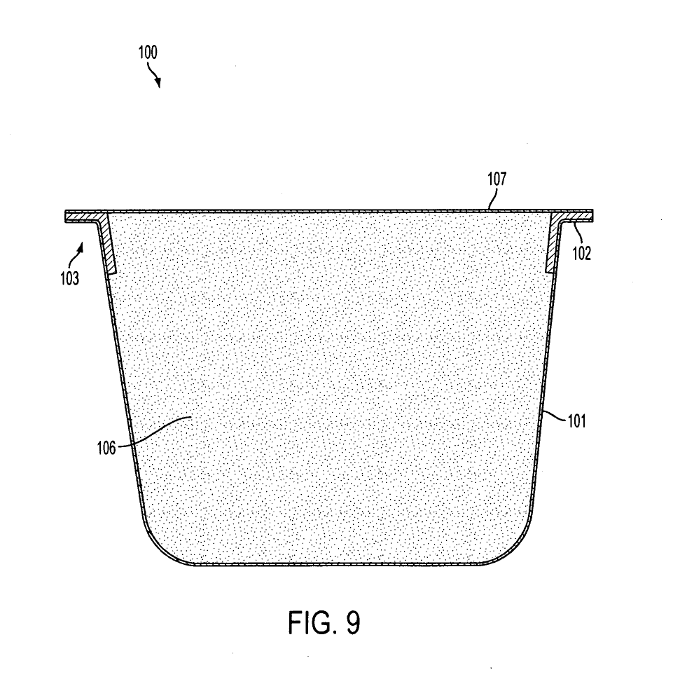

FIG. 9 shows an alternative embodiment of a container 100 according to the invention. The container 100 includes a container body 101, a ring 103 and a barrier-film membrane 107. In this embodiment, at least a portion of the reinforcement ring 103 is disposed inside the upper wall of the container 101. In addition, the upper wall of the container can extend underneath a horizontal part portion of the ring 103 and thereby become integral with the ring 103 and with the outer edge of the barrier-film membrane 107, increasing the stiffness of the membrane 107.

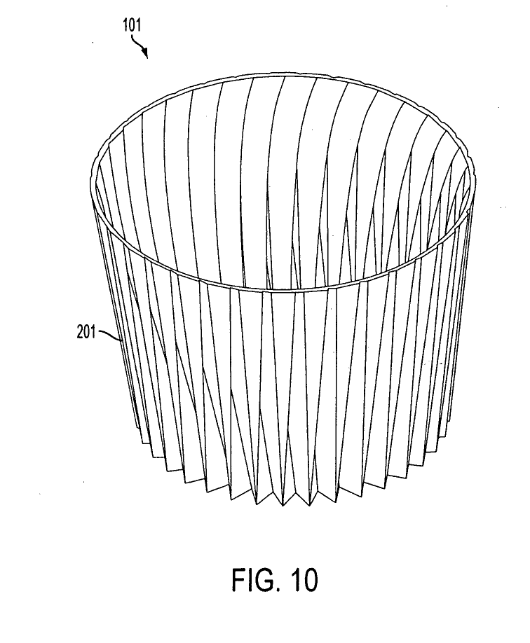

FIG. 10 shows an alternative embodiment of a container body 101 according to the invention. The container body 101 can be provided with pleated portions 201 to provide at least a partially pleated surface. A top portion of the container body 101 can be provided with a substantially flat surface around a perimeter of its top portion to add additional surface area for connection to the reinforcement ring 103. The pleated portions can extend to a lower portion of the container body 101 and thereby stiffen the container body 101. By providing pleated portions, the container body can thereby be stiffened to be substantially self-supporting and thus improve the aesthetic appearance of the container body, its structure and reduce the possibility of being inadvertently squeezed and compressed when being handled by a user.

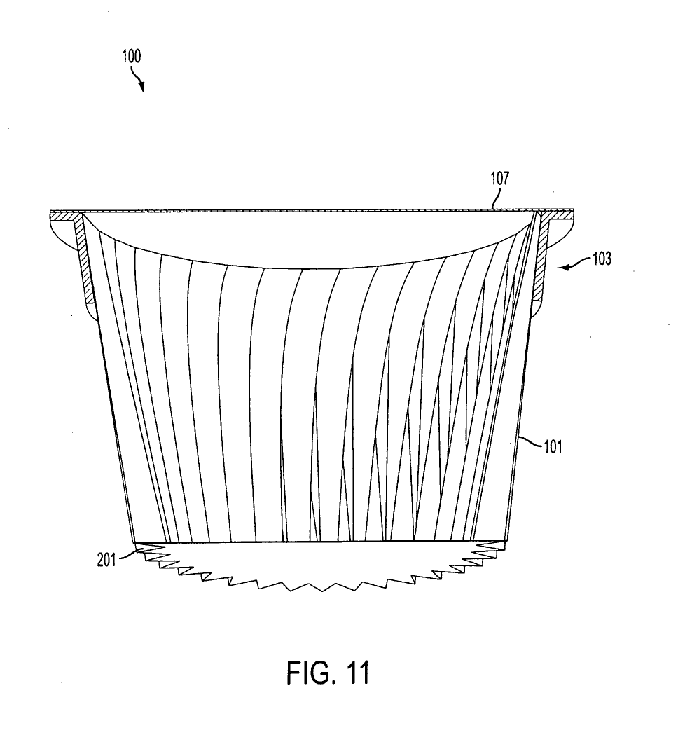

FIG. 11 shows a cross-sectional view of an alternative embodiment of a container 100 according to the invention having a container body 101 with pleated portions 201. A top portion of the container body 101 can be provided with a substantially flat surface around is perimeter, and can thereby be more effectively connected to a reinforcement ring 103. The pleated portions can extend to a lower portion of the container body 101 and thereby stiffen the container body 101. The top portion of the container body 101 can be sealed inside the vertical wall of the outer reinforcement ring 103. In addition, the barrier-film closing membrane 107 can be sealed directly on the horizontal surface 104 of the outer reinforcement ring 103.

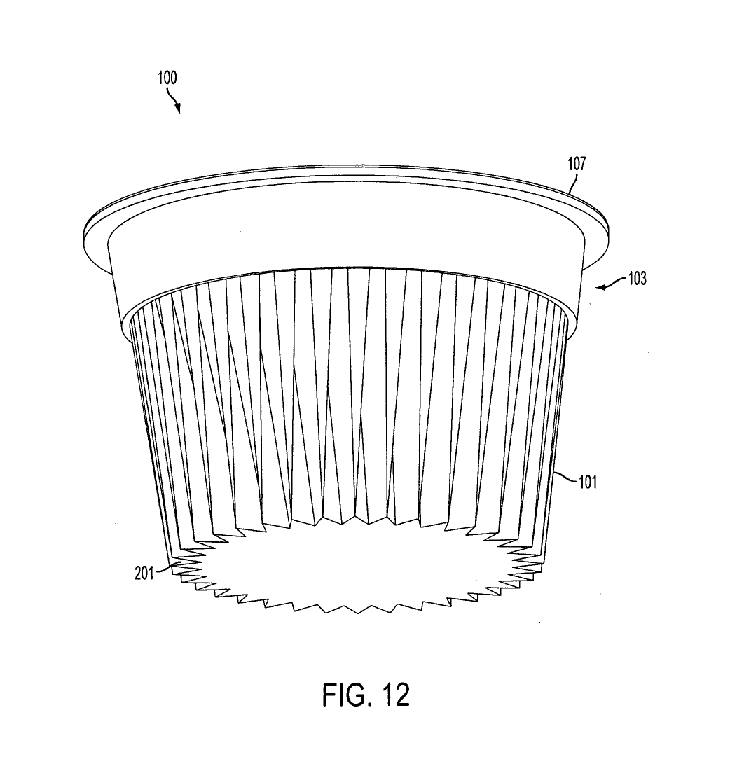

FIG. 12 shows a perspective view of an alternative embodiment of a container 100 according to the invention, such as shown in FIG. 12, having a container body 101 with pleated portions 201. The container body 101 can be surrounded at the top by a reinforcement ring 103.

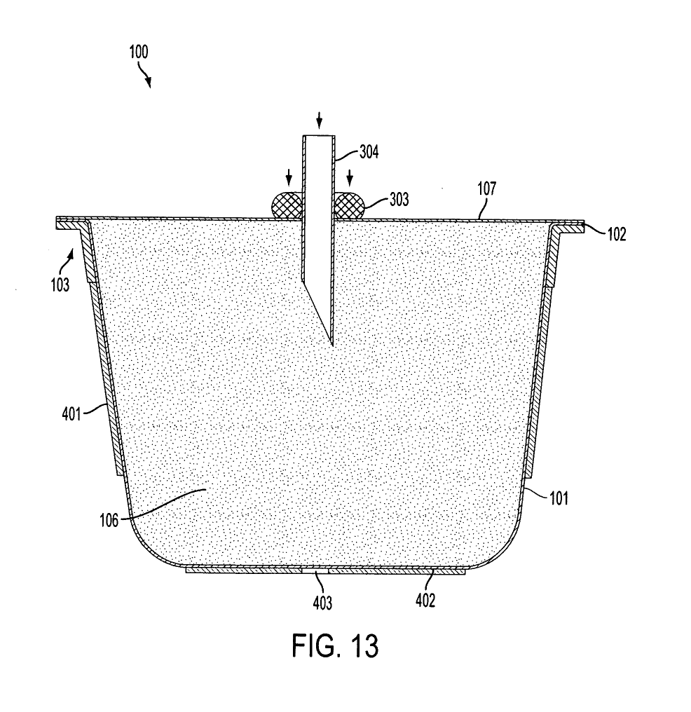

FIG. 13 shows an alternative embodiment of a container 100 according to the invention adapted for use with a machine 300, such as a coffee maker or other brewing machine wherein the needle 304 has pierced the membrane 107. The container 100 includes a container body 101, a reinforcement ring 103 and a barrier-film membrane 107. The container body 101 can be formed from a plurality of materials, such as a less porous material and a more porous material. For example, a sleeve 401 of less porous material can be provided at a top portion of the container body 101 comprising a main material of more porous material so that fluid is disposed to flow through a greater portion of the brewing material before flowing through the more porous material of the container body 101. Preferably, the sleeve permits at least a portion of the fluid to pass through the portion of the container body having the sleeve.

It can be appreciated that the container body comprise a sufficient permeable filtrating surface to let the hot water go through the dry medium and easily flow downwards. For example, it can be appreciated that in one embodiment by varying the porosity of the material, one can affect the strength of the brewed beverage. Accordingly, an embodiment of a container 100 according to the invention having a sleeve 401 can provide a solution for adapting a container according to the tastes of a user. As a further benefit, an embodiment of a container 100 according to the invention having a sleeve 401 can provide a solution for adapting a container having a container body 101 whose main material is too porous to suit the tastes of a user, whereby sleeve can be provided to reduce the overall porosity if needed.

Accordingly, the container body 101 can be formed with the sleeve overlapping a portion of the more porous material of the container body 101, whereby fluid passes through both the more porous material of container body and the less porous material of the sleeve. Alternatively, the container body 101 can be formed with the sleeve adjoining a portion of the more porous material of the container body 101, whereby fluid can pass through the more porous material of container body and the less porous material of the sleeve separately. In one embodiment, the sleeve can be provided to extend to a distance below where the aperture of a needle is disposed when in use whereby fluid can be caused to flow into brewing material above the level of the aperture of the needle. The sleeve 401 can also overlap a portion of the ring 103, and can be provided on the inside of the container body 101 or outside.

In addition, or in the alternative a spreader disc 402 can be provided. The spreader disc 402 can conform to the shape of a lower portion of the container body 101, such as a disc, and can be fabricated from a les porous material. Accordingly, fluid passing though the brewing material 106 is disposed to fill the container and saturate the brewing material, and can further be disposed to flow through the sides and bottom portion of the container body at a slower rate without requiring additional material of the container body. In addition, the spreader disc 402 can be provided at an outside portion of the container body 101. In an alternative embodiment, the spreader disc 402 can be removable by a user who may desire to have stronger or lighter brewed beverage. In addition, the spreader disc 402 can be removable by a user who may desire to enjoy the aroma of the brewing material on an inside portion of the spreader disc 402, such as while the container 100 is in use in the machine 300. The spreader disc 402 can be provided with an aperture 403 to facilitate flow of fluid through an entirety of the brewing material.

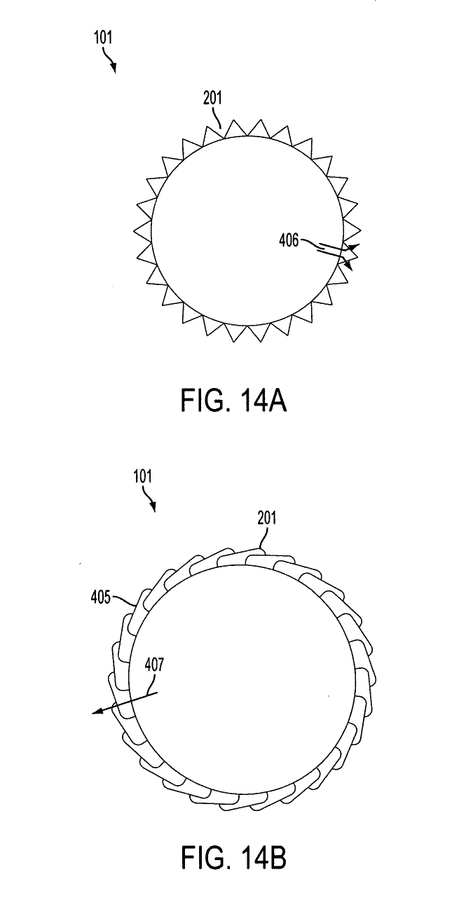

FIG. 14 shows an alternative embodiment of a container body 101 according to the invention, with FIG. 14A showing a cross-section of a lower portion of the container body 101, and FIG. 14B showing an upper portion of the container body 101. The container body 101 can be provided with pleated portions 201 to provide at least a partially pleated surface at the lower portion and can provide fluid flow 406 through each side of a pleated portion 201 separately. A top portion of the container body 101 can be provided with pleated portions 201 that have been flatted against one another to form a substantially flat surface around a perimeter of the top portion of the container body 101, and can thereby be more effectively connected to a ring 103 of a container 100, or proximate to the vertical wall portion of the reinforcement ring. In addition, the overlapping portions can provide reduced fluid flow 407 through each overlap portion 405 of the pleated areas 201 of the container body 101. By providing overlapping pleated portions 201, the container body 101 can thereby promote fluid flow throughout an entire column of brewing material in the container body by reducing the flow out of the container at a top portion of the container while utilizing a container body 101 that can be fabricated from a single piece of material. It can be appreciated by a person of ordinary skill in the art to choose a material for the container body 101 having sufficient porosity to permit sufficient flow of fluid though the product and container body 101 so that a brewed product can be produced having a desired strength using the container 100 with existing brewing machines.

In addition, or in the alternative, the container body 101 can be provided with pleated portions 201 that are at least partially flattened, and thus a container 100 according to the invention can be provided in a more compact form during shipping and/or storage prior to use. For example, during fabrication the expanded portions of the pleats of the container body, as shown in FIG. 14B, can be flattened by partially twisting the container body so as to flatten the pleats, such as shown in FIG. 14B. The pleated portions can be provided as having an expanded state, such as shown in FIG. 14A, and a collapsed storage state, such as shown in FIG. 14B,.wherein said pleated portions are partially flattened and overlapping one another in a collapsed storage state

The invention may be accomplished in various manners concerning dimensions, structure and materials used for making different reinforcements and how to make them integral with the container. For example, the membrane can be provided with additional thickness to provide for additional rigidity.

Now that the original innovative characteristics of the present invention have been disclosed, anyone with average technical expertise in this specific technological field shall be capable of making thermoformed filtering permeable or filter paper containers, improved by stiffening the structure without much inventive effort, but with simple logic and technical deductions, having the basic features been described, and illustrated in the following claims.

1. A filtering container for water soluble beverage making products, comprising:
a water permeable container body thermoformed from a flat film providing container space to receive a water soluble brewing product, the container body having a flat rim extending around the opening of the container;
a reinforcement ring with a horizontal portion that is connected to and supports the flat rim of the container body, and
a membrane,
wherein the horizontal portion has a substantially flat top surface which forms a complementary ring, and wherein the flat rim of the container is connected to the membrane which closes the opening of the container, wherein the reinforcement ring further comprises a vertical wall portion connected to the container body for providing additional rigidity to the reinforcement ring, and wherein the reinforcement ring maintains the membrane in a substantially stiff manner.

2. A filtering container according to claim 1, wherein the container body, the reinforcement ring, and the membrane are substantially comprised of biodegradable material, and wherein the horizontal portion forms a circular ring.

3. A filtering container for a water soluble beverage making products, comprising:
a water permeable container body thermoformed from a flat film providing container space to receive a water soluble brewing product, the container body having a flat rim extending around the opening of the container;
a reinforcement ring with a horizontal portion that is connected to and supports the flat rim of the container body, and
a membrane,
wherein the horizontal portion has an under surface which forms a complementary ring, and wherein the horizontal portion has a substantially flat the top surface which is connected to the membrane and which closes the opening of the container, wherein the reinforcement ring further comprises a vertical wall portion connected to the container body for providing additional rigidity to the reinforcement ring, and wherein the reinforcement ring maintains the membrane in a substantially stiff manner.

4. A filtering container according to claim 3, wherein the container body, the reinforcement ring, and the membrane are substantially comprised of biodegradable material, and wherein the horizontal portion forms a circular ring.

5. A filtering container according to claim 1, wherein the vertical wall portion is connected to the horizontal portion of the reinforcement ring at greater than a right angle whereby the vertical wall portion leans in a direction towards a center axis of the reinforcement ring.

6. A filtering container according to claim 3, wherein the vertical wall portion is connected to the horizontal portion of the reinforcement ring at greater than a right angle whereby the vertical wall portion leans in a direction towards a center axis of the reinforcement ring.

7. A filtering container according to claim 5, wherein the horizontal portion of the reinforcement ring has a bottom surface and wherein the membrane is folded around an outer edge of the ring and is connected to at least a portion of a bottom surface of the ring.

8. A filtering container according to claim 5, wherein the container body includes pleated portions whereby the container body is stiffened to be substantially self-supporting.

9. A filtering container according to claim 5, wherein the container body further comprises a sleeve, wherein the sleeve cooperates with the container body to provide a lesser permeable portion of the container body.

10. A filtering container according to claim 5, wherein the container body further comprises a spreader disc disposed at a bottom center portion of the container body, wherein the spreader disc cooperates with the container body to provide a lesser permeable portion of the container body.

11. A filtering container according to claim 5, wherein the spreader disc is disposed on an outside surface of the container body and is removable.

12. A filtering container according to claim 5, wherein the spreader disc further comprises a spreader disc aperture disposed at a center portion of the spreader disc.

13. A filtering container according to claim 6, wherein the vertical wall portion is connected to the horizontal portion of the reinforcement ring at approximately a 7 degree angle.

14. A filtering container according to claim 7, further comprising a resin and a overlapping portion where the membrane overlaps the rim, and wherein the resin, membrane and rim are heat-sealed whereby the membrane is supported in a substantially stiff manner.

15. A filtering container according to claim 5, wherein the container body includes pleated portions, said pleated portions being partially flattened and overlapping one another proximate to the vertical wall portion of the reinforcement ring.

16. A filtering container according to claim 5, wherein the container body includes pleated portions, said pleated portions having an expanded state and a collapsed storage state, wherein said pleated portions are partially flattened and overlapping one another in a collapsed storage state.

17. A filtering container according to claim 3, wherein the container body, the reinforcement ring, and the membrane are substantially comprised of biodegradable material, and wherein the shape of the horizontal portion is selected from the group consisting of oval, square and rectangular.

18. A filtering container according to claim 1, wherein the reinforcement ring is melded with the flat rim of the container body and the membrane at a region proximate to the flat rim.

19. A filtering container according to claim 3, wherein the horizontal portion of the reinforcement ring is melded with the flat rim of the container body and the membrane at a region proximate to the flat rim.

20. A filtering container for water soluble beverage making products, comprising:
a water permeable container body thermoformed from a flat film providing container space to receive a water soluble brewing product;
a membrane, and
a reinforcement ring with a horizontal portion and a vertical wall portion for providing additional rigidity to the reinforcement ring,
wherein the vertical wall portion is connected to the container body, and
wherein the horizontal portion has a substantially flat top surface which forms a complementary ring that is connected to the membrane which closes the opening of the container and maintains the membrane in a substantially stiff manner.

21. A filtering container according to claim 20, wherein the container body, the reinforcement ring, and the membrane are substantially comprised of biodegradable material, and wherein the horizontal portion forms a circular ring.

22. A filtering container according to claim 20, wherein the horizontal portion of the reinforcement ring is melded with the flat rim of the container body and the membrane at a region proximate to the flat rim.

23. A filtering container according to claim 20, wherein the vertical wall portion is connected to the horizontal portion of the reinforcement ring at greater than a right angle whereby the vertical wall portion leans in a direction towards a center axis of the reinforcement ring.

24. A filtering container according to claim 20, wherein the container body includes pleated portions, said pleated portions being partially flattened and overlapping one another proximate to the vertical wall portion of the reinforcement ring.

25. A filtering container according to claim 20, wherein the container body includes pleated portions, said pleated portions having an expanded state and a collapsed storage state, wherein said pleated portions are partially flattened and overlapping one another in a collapsed storage state.
